(19) United States
(12) Patent Application Publication
(10) Pub. No.: US 2026/0219520 A1
(43) Pub. Date: Jul. 30, 2026

(54) DETERMINING A PROGRESSIVE LENS OPTICAL DESIGN

(71) Applicant: ADDON OPTICS LTD., Netanya (IL)

(72) Inventors: Jed Arkin, Savyon (IL); Haim Engler, Maale Adumim (IL)

(21) Appl. No.: 19/568,096

(22) Filed: Mar. 16, 2026

Related U.S. Application Data
(63) Continuation-in-part of application No. 17/904,036, filed on Aug. 11, 2022, now Pat. No. 12,601,928.

(51) Int. Cl. G02C 7/06; G02C 7/02; G02C 7/08

(52) U.S. Cl. CPC G02C 7/061; G02C 7/027; G02C 7/028; G02C 7/086

(57) ABSTRACT

Apparatus and methods are described for use with a temporary progressive lens that is configured for a subject's temporary use based upon an initial progressive-lens optical design. While the temporary progressive lens is inside a frame that is configured to be worn by the subject, data are received from one or more sensors that are associated with the frame and that are configured to detect when the frame is removed from and/or repositioned on the subject's face, while the subject performs activities. Based upon the received data and reasons provided by the subject for the frame having been removed from and/or repositioned on the subject's face, an optimized optical design for the progressive lens is determined. Other applications are also described.

### CROSS-REFERENCE TO RELATED APPLICATIONS

The present application is a Continuation-in-Part of U.S. patent application Ser. No. 17/904,036 to Arkin filed Aug. 11, 2022 (published as US 2023/0127754), which is a US national phase of International Application PCT/IB2021/050759 to Arkin, filed Jan. 31, 2021 (published as WO 21/161125), entitled “Determining a progressive lens optical design,” which claims priority from U.S. Provisional Ser. No. 62/977,313 to Arkin et al., filed Feb. 16, 2020, entitled “Determining a progressive lens optical design,” all of which are incorporated herein by reference.

### FIELD OF EMBODIMENTS

Some applications of the present invention generally relate to ophthalmic lenses. In particular, some applications relate to determining a subject's progressive lens optical design.

### BACKGROUND

Presbyopia is a condition that gradually affects most of the population over age 40. The condition results in progressively worsening ability to focus clearly on close objects. Presbyopia is usually treated with multifocal eyeglasses, progressive eyeglasses or contact lenses, since laser-assisted in situ keratomileusis (i.e., LASIK) and other types of surgery are unsuitable for treating this condition.

Corrective lenses are used in eyeglasses to correct presbyopia and other disorders of accommodation. Many people who suffer from presbyopia, additionally suffer from myopia (i.e., near-sightedness). A basic solution for such people is the use of multifocal spectacle lenses. Multifocal spectacle lenses contain two or more lens powers, with each power being suitable for objects that are at respective distances. Bifocals contain two lens powers; trifocals contain three. Progressive spectacle lenses are characterized by a gradient of increasing lens power. The gradient starts at the wearer's distance prescription and reaches a maximum addition power, or the full reading addition, in the lower portion of the lens. The addition in the middle of the lens usually enables clear vision in intermediate ranges, such as reading text on a computer screen. The length of the progressive power gradient on the lens surface depends on the design of the lens, with a final addition power typically being between 0.50 and 3.50 Diopters. The addition value prescribed depends on the level of presbyopia of the patient.

Multifocal and progressive lenses are typically relatively expensive. A significant contributing factor to the high cost of multifocal and progressive lenses is the fact that there is a huge number of (several million) possible optical design combinations, when accounting for near-vision correction, far-vision correction, astigmatism, and angle of astigmatism. The large number of possible combination means that most optical designs cannot be held in stock, but rather must be manufactured on a bespoke basis based on the patient's needs. In addition, there are relatively high numbers of patients who do not adapt to the use of progressive lenses. For these reasons, opticians are often reluctant to recommend progressive lenses, particularly for younger patients.

### SUMMARY

In accordance with some applications of the present disclosure, a temporary progressive lens is configured for a subject's temporary use (for example, for a period of between 2 hours and four weeks), based upon an initial progressive-lens optical design. Typically, during use of the temporary progressive lens by the subject, data that are indicative of suitability of the optical design of the lens for activities that are performed by the subject are received. For example, the subject may record such data, and/or the data may be recorded automatically (e.g., using sensors that are associated with a frame of the glasses). Typically, the optical design of the progressive lens that is required by the subject is optimized based upon the received data. Further typically, a non-temporary progressive lens is manufactured based upon the optimized optical design.

For some applications, the temporary progressive lens includes a combination of a base lens and an additional lens. For some such applications, the base lens is a single-focus, far-vision corrective lens and the additional lens is coupled to the single-focus, far-vision corrective lens. Since the progressive lens is only for temporary use and is typically based upon an initial assessment of the lens design that is required by the subject, it is desirable to manufacture the progressive lens using a relatively cheap manufacturing technique. Typically, manufacturing a progressive lens using a combination of a base lens and additional lens is cheaper than manufacturing a bespoke progressive lens using traditional manufacturing techniques in which a single lens is formed such as to provide all of the optical functionalities of the progressive lens (e.g., corrections for near vision, for far vision, for astigmatism, etc.).

Furthermore, it is desirable that the temporary progressive lens be supplied to the patient as quickly as possible, in order to expedite the supply of a permanent progressive lens to the subject. Typically, manufacturing a progressive lens using a combination of a base lens and an additional lens allows the temporary lens to be provided to the patient more quickly than if a single lens were to be shaped according to the subject's optical requirements. This is because the temporary progressive lens can typically be manufactured at a retail location using a relatively small stock of base lenses and additional lenses, whereas manufacturing a bespoke progressive lens using traditional manufacturing techniques is typically performed off-site at a laboratory. For some applications, once the optical design of the subject's lens has been optimized using the techniques described herein, a non-temporary progressive lens that matches the optimized optical design is manufactured using traditional manufacturing techniques, in which a single lens is configured to provide all of the optical functionalities of the progressive lens. Alternatively, even the non-temporary lens that matches the optimized lens design is manufactured using a combination of a base lens and an additional lens.

For some applications, one or more sensors are coupled to a frame of glasses within which the temporary progressive lens is placed. For example, the sensors may include one or more location and/or orientation sensors (e.g., accelerometers) and/or proximity sensors that are configured to provide sensor data that are indicative of when the glasses are removed from the subject's face, repositioned, or are placed upon the subject's face. Removal of glasses or repositioning of the glasses on the wearer's nose are indicative of visual discomfort of the wearer. For some applications, in response to detecting that the subject's glasses have been removed or repositioned, a computer processor prompts the subject to provide a reason for the removal and/or repositioning of the glasses. For example, the computer processor may generate context-specific questions or provide the subject with choices regarding the reason for the removal. For some applications, such prompts are output on the subject's smartphone (or other electronic device).

For some applications, the sensors include a gyroscope (e.g., a solid-state gyroscope). Typically, the gyroscope provides data that are indicative of the subject's head position. For some applications, based upon these data, the computer processor derives how much time a subject spends utilizing near, intermediate and far-vision portions of the progressive lenses in his/her daily activities. For some applications, the sensors include one or more solid-state spirit levels that are configured to generate data that are indicative of the degree of the subject's head tilt (which, in turn, is indicative of the portion of the lens through which the subject is looking). For some applications, the sensors include a miniature camera that is configured to monitor the subject's pupils, and/or a miniature camera that is configured to monitor the subject's eyelids, such that the frequency and/or duration of the subject's blinks may be measured. Alternatively or additionally, the sensors include an ambient light sensor. For some applications, the sensors include a sensor (e.g., a rangefinder) that is configured to measure the distance to viewed objects that correspond to the direction of the subject's gaze. For some applications, the sensors include a real-time clock, a motion-detection sensor, an accelerometer, a GPS locator, and/or a combination thereof, that are configured to provide data relating to the subject's movement, location, time-of-day, and speed of the subject (e.g., such as to determine whether the subject is driving, biking, running, walking, and/or stationary), while using the temporary progressive lens.

There is therefore provided, in accordance with some applications of the present disclosure, a method including:
providing a temporary progressive lens that is configured for a subject's temporary use, based upon an initial progressive-lens optical design;
receiving data that are indicative of suitability of the optical design for activities that are performed by the subject, the data being generated during use of the temporary progressive lens by the subject;
based upon the received data, optimizing the optical design for a progressive lens for the subject; and
outputting the optimized optical design.

In some applications, providing the temporary progressive lens includes providing a temporary progressive lens that is made of a base lens and an additional lens, the base lens including a single-focus optically corrective lens, and the additional lens being configured to convert the base lens to a progressive lens.

In some applications, receiving the data includes receiving data that are generated manually by the subject.

In some applications, receiving the data includes receiving data that are indicative of how much time the subject spends performing respective activities.

In some applications, receiving the data includes receiving data that are indicative of how use of the temporary progressive lens correlates with performance of respective activities by the subject.

In some applications, receiving the data includes receiving data that are generated automatically via sensors. In some applications, receiving the data includes receiving data that are generated automatically via sensors that are disposed on a frame of glasses within which the temporary progressive lens is placed. In some applications, receiving the data includes receiving data from one or more sensors that are configured to detect when the glasses are removed from the subject's face, repositioned, and placed upon the subject's face. In some applications, receiving the data includes receiving data from one or more gyroscopes that are indicative of a head position of the subject. In some applications, receiving the data includes receiving data from one or more cameras that are configured to monitor a pupil of an eye of the subject. In some applications, receiving the data includes receiving data from one or more cameras that are configured to monitor an eyelid of the subject. In some applications, receiving the data includes receiving data from one or more light sensors that are configured to monitor a level of ambient light. In some applications, receiving the data includes receiving data from one or more sensors that are configured to measure a distance to viewed objects that correspond to a direction of a gaze of the subject. In some applications, receiving the data includes receiving data from one or more solid-state spirit levels that are configured to generate data that are indicative of a degree of head tilt of the subject.

There is further provided, in accordance with some applications of the present disclosure, apparatus including:
a temporary progressive lens configured for temporary use by a subject, based upon an initial progressive-lens optical design; and
at least one computer processor configured to:
   receive data that are indicative of suitability of the optical design for activities that are performed by the subject, the data being generated during use of the temporary progressive lens by the subject;
   based upon the received data, determine an optimized optical design for a progressive lens for the subject; and
   output the optimized optical design.

In some applications, the temporary progressive lens includes a base lens and an additional lens, the base lens including a single-focus optically corrective lens, and the additional lens being configured to convert the base lens to a progressive lens.

In some applications, the computer processor is configured to receive the data by receiving data that are generated manually by the subject. In some applications, the computer processor is configured to receive the data by receiving data that are indicative of how much time the subject spends performing respective activities.

In some applications, the computer processor is configured to receive the data by receiving data that are indicative of how use of the temporary progressive lens correlates with performance of respective activities by the subject.

In some applications, the apparatus further includes one or more sensors, and the computer processor is configured to receive the data by receiving data that are generated automatically by the one or more sensors. In some applications, the apparatus further includes a frame of glasses that is configured to hold the temporary progressive lens, the one or more sensors are disposed on the frame. In some applications, the one or more sensors are configured to acquire data that are indicative of when the glasses are removed from the subject's face, repositioned, and placed upon the subject's face. In some applications, the one or more sensors are configured to acquire data that are indicative of a head position of the subject. In some applications, the one or more sensors include one or more cameras that are configured to monitor a pupil of an eye of the subject. In some applications, the one or more sensors include one or more cameras that are configured to monitor an eyelid of the subject. In some applications, the one or more sensors include one or more light sensors that are configured to monitor a level of ambient light. In some applications, the one or more sensors include one or more sensors that are configured to measure a distance to viewed objects that correspond to a direction of a gaze of the subject. In some applications, the one or more sensors include one or more solid-state spirit levels that are configured to generate data that are indicative of a degree of head tilt of the subject.

There is further provided, in accordance with some applications of the present disclosure, a method for use with a temporary progressive lens that is configured for a subject's temporary use, based upon an initial progressive-lens optical design, the method including:
placing the temporary progressive lens inside a frame that is configured to be worn by the subject;
receiving data from one or more sensors that are associated with the frame and that are configured to acquire data that are indicative of use of the temporary progressive lens by the subject, while the subject performs activities;
based upon the received data, determining an optimized optical design for the progressive lens; and
outputting the optimized optical design.

In some applications, placing the temporary progressive lens inside the frame includes placing inside the frame a temporary progressive lens that is made of a base lens and an additional lens, the base lens including a single-focus optically corrective lens, and the additional lens being configured to convert the base lens to a progressive lens.

In some applications, receiving the data from the one or more sensors includes receiving data that are indicative of how much time the subject spends performing respective activities.

In some applications, receiving the data from the one or more sensors includes receiving data that are indicative of how use of the temporary progressive lens correlates with performance of respective activities by the subject.

In some applications, receiving the data from the one or more sensors includes receiving data from one or more sensors that are configured to detect when the frame is removed from the subject's face, repositioned, and placed upon the subject's face. In some applications, receiving the data from the one or more sensors includes receiving data from one or more gyroscopes that are configured to detect data that are indicative of a head position of the subject. In some applications, receiving the data from the one or more sensors includes receiving data from one or more cameras that are configured to monitor a pupil of an eye of the subject. In some applications, receiving the data from the one or more sensors includes receiving data from one or more cameras that are configured to monitor an eyelid of the subject. In some applications, receiving the data from the one or more sensors includes receiving data from one or more light sensors that are configured to monitor a level of ambient light. In some applications, receiving the data from the one or more sensors includes receiving data from one or more sensors that are configured to measure a distance to viewed objects that correspond to a direction of a gaze of the subject. In some applications, receiving the data from the one or more sensors includes receiving data from one or more solid-state spirit levels that are configured to generate data that are indicative of a degree of head tilt of the subject.

There is further provided, in accordance with some applications of the present disclosure, apparatus for use with a temporary progressive lens configured for temporary use by a subject, based upon an initial progressive-lens optical design, the apparatus including:
a frame in which the temporary progressive lens is configured to be placed, the frame being configured to be worn by the subject and including one or more sensors configured to acquire data that are indicative of use of the temporary progressive lens by the subject, while the subject performs activities; and
at least one computer processor configured to:
   receive the data from the sensors;
   based upon the received data, determine an optimized optical design for a progressive lens for the subject; and
   output the optimized optical design.
In some applications, the computer processor is configured to receive the data by receiving data that are indicative of how much time the subject spends performing respective activities.

In some applications, the computer processor is configured to receive the data by receiving data that are indicative of how use of the temporary progressive lens correlates with performance of respective activities by the subject.

In some applications, the one or more sensors are configured to acquire data that are indicative of when the frame is removed from the subject's face, repositioned, and placed upon the subject's face. In some applications, the one or more sensors are configured to acquire data that are indicative of a head position of the subject. In some applications, the one or more sensors include one or more cameras that are configured to monitor a pupil of an eye of the subject. In some applications, the one or more sensors include one or more cameras that are configured to monitor an eyelid of the subject. In some applications, the one or more sensors include one or more light sensors that are configured to monitor a level of ambient light. In some applications, the one or more sensors include one or more sensors that are configured to measure a distance to viewed objects that correspond to a direction of a gaze of the subject. In some applications, the one or more sensors include one or more solid-state spirit levels that are configured to generate data that are indicative of a degree of head tilt of the subject.

There is further provided, in accordance with some applications of the present disclosure, an apparatus for use with a temporary progressive lens configured for temporary use by a subject, based upon an initial progressive-lens optical design, and an augmented-reality headset, the apparatus including at least one computer processor configured to:
receive data from the augmented-reality headset that are indicative of suitability of the optical design for activities that are performed by the subject using the augmented-reality headset, the data being generated during use of the temporary progressive lens and the augmented-reality headset by the subject;

based upon the received data, determine an optimized optical design for a progressive lens for use with the augmented-reality headset for the subject; and
output the optimized optical design.

In some applications, the augmented-reality headset includes one or more sensors and the at least one computer processor is configured to receive the data that are indicative of suitability of the optical design for activities that are performed by the subject using the augmented-reality headset from the one or more sensors.

In some applications, the one or more sensors include sensors selected from the group consisting of:
sensors configured to acquire data that are indicative of when the augmented-reality headset is removed from the subject's face, repositioned, and placed upon the subject's face;
sensors configured to acquire data that are indicative of a head position of the subject;
cameras that are configured to monitor a pupil of an eye of the subject;
cameras that are configured to monitor an eyelid of the subject;
one or more light sensors that are configured to monitor a level of ambient light;
sensors configured to measure a distance to viewed objects that correspond to a direction of a gaze of the subject;
one or more solid-state spirit levels that are configured to generate data that are indicative of a degree of head tilt of the subject; and
cameras that are configured to detect external surroundings of the subject.

In some applications: the temporary progressive lens includes a base lens and an additional lens, the base lens including a single-focus optically corrective lens, and the additional lens being configured to convert the base lens to a progressive lens; and the at least one computer processor is configured to receive the data that are indicative of suitability of the optical design for activities that are performed by the subject using the augmented-reality headset, the data being generated during use of the temporary progressive lens including the base lens and the additional lens.

In some applications, the computer processor is configured to receive the data by receiving data that are indicative of how use of the temporary progressive lens correlates with performance of respective activities by the subject using the augmented-reality headset.

In some applications, the at least one computer processor is configured to determine the optimized optical design based on data indicative of areas of the lens used for digital overlays to ensure clarity in the areas of the lens.

In some applications, the at least one computer processor is configured to determine the optimized optical design by determining a gaze direction and distance at which augmented-reality notifications are presented and ensuring that a prescription of the subject is adequately supported at the determined gaze direction and distance.

In some applications, the at least one computer processor is configured to determine the optimized optical design by shifting or widening an intermediate corridor of the progressive lens aligned with a projection angle of the augmented-reality headset.

In some applications, the at least one computer processor is configured to determine the optimized optical design based on a gaze direction and distance at which augmented-reality data are presented, so as to mitigate augmented-reality-induced visual strain.

In some applications, the at least one computer processor is configured to determine the optimized optical design by providing a clear optical zone in the gaze direction and distance where augmented-reality data are presented to reduce the effort required by an eye of the subject.

In some applications, the at least one computer processor is configured to determine the optimized optical design by distributing add power across the lens for more comfortable viewing of augmented-reality content.

In some applications, the at least one computer processor is configured to determine the optimized optical design based on augmented-reality data indicative of regions where augmented-reality data often appear, so as to minimize distortion in augmented-reality interaction areas.

In some applications, the at least one computer processor is configured to determine the optimized optical design by reducing astigmatism and distortion in regions where augmented-reality data often appear.

In some applications, the apparatus further includes the temporary progressive lens

In some applications, the apparatus further includes the augmented-reality headset.

The present disclosure will be more fully understood from the following detailed description of embodiments thereof, taken together with the drawings, in which:

### BRIEF DESCRIPTION OF THE DRAWINGS

FIG. 1 is a schematic illustration of a pair of glasses that contains one or more temporary progressive lenses, in accordance with some applications of the present disclosure;

FIG. 2 is a schematic illustration of a pair of glasses that has sensors coupled thereto, in accordance with some applications of the present disclosure;

FIG. 3 is a schematic illustration of at least one temporary progressive lens and an augmented-reality headset, in accordance with some applications of the present disclosure;

FIG. 4A is a schematic illustration of a progressive lens not optimized for use with an augmented-reality headset; and

FIG. 4B is a schematic illustration of an optimized progressive lens optimized for use with an augmented-reality headset.

### DETAILED DESCRIPTION OF EMBODIMENTS

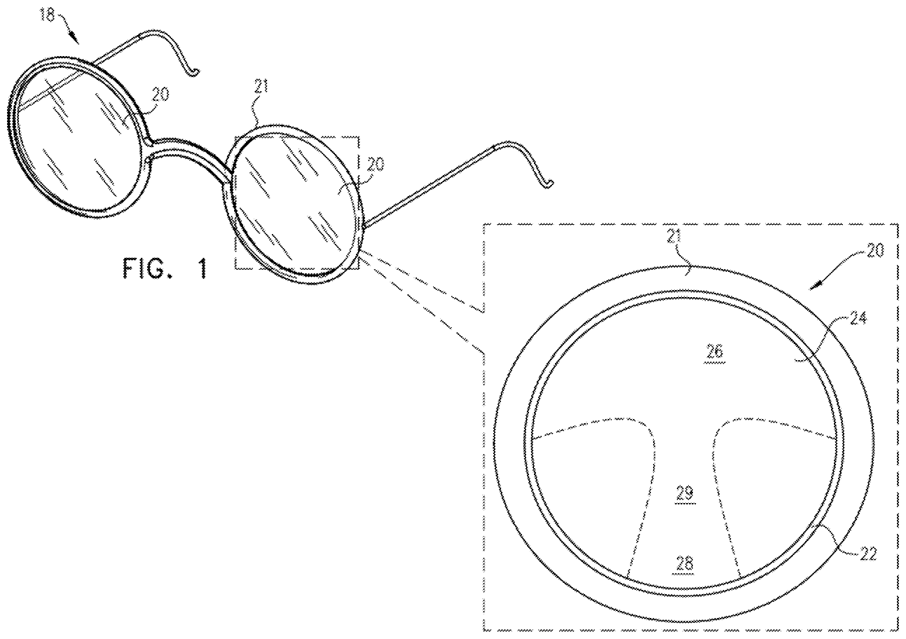

Reference is now made to FIG. 1, which is a schematic illustration of a pair of glasses 18 that includes one or more progressive lenses 20, in accordance with some applications of the present disclosure. For some applications, progressive lens 20 is a temporary progressive lens that is configured for a subject's temporary use (for example, for a period of between 2 hours and four weeks), based upon an initial progressive-lens optical design. Typically, during use of the temporary progressive lens by the subject, data that are indicative of suitability of the optical design of the lens for activities that are performed by the subject are received. For example, the subject may record such data, and/or the data may be recorded automatically (e.g., using sensors that are associated with a frame 21 of the glasses), as described in further detail hereinbelow. Typically, the optical design of the progressive lens that is required by the subject is optimized based upon the received data. Further typically, a non-temporary progressive lens is manufactured based upon the optimized optical design. For some applications, based upon the received data, a determination is made that progressive lenses are unsuitable for the subject.

Referring to the enlarged portion of FIG. 1, for some applications, temporary progressive lens 20 includes a combination of a base lens 22 and an additional lens 24. For some such applications, base lens 22 is a single-focus, far-vision corrective lens and additional lens 24 is coupled to the single-focus, far-vision corrective lens. Typically, additional lens 24 is coupled to the inner surface of base lens 22 (i.e., the surface of the lens that is closer to the user's eyes when the lens is incorporated into glasses that are worn by the user). Alternatively, additional lens 24 is coupled to the outer surface of base lens 22 (i.e., the surface of the lens that is farther from the user's eyes when the lens is incorporated into glasses that are worn by the user). Typically, temporary progressive lens 20 includes a far-vision corrective region 26, a near-vision corrective region 28, and a transition region 29. For some applications, additional lens 24 is coupled to base lens 22 via an adhesive layer, and/or is coupled to the base lens using alternative techniques, e.g., as described in U.S. Pat. No. 9,995,948 to Arieli, which is incorporated herein by reference. It is noted that, in the enlarged portion of FIG. 1, a gap is shown between the outer edge of the additional lens and glasses frame 21. Typically, such a gap would not exist in practice, and such a gap is only shown in FIG. 1 for illustrative purposes, in order to show additional lens 24 and base lens 22.

Since progressive lens 20 is only for temporary use and is typically based upon an initial assessment of the lens design that is required by the subject, it is desirable to manufacture progressive lens 20 using a relatively cheap manufacturing technique. Typically, manufacturing a progressive lens using a combination of base lens 22 and additional lens 24 of the type shown in FIG. 1 is cheaper than manufacturing a bespoke progressive lens using traditional manufacturing techniques in which a single lens is formed such as to provide all of the optical functionalities of the progressive lens (e.g., corrections for near vision, for far vision, for astigmatism, etc.).

Furthermore, it is desirable that the temporary progressive lens 20 be supplied to the patient as quickly as possible, in order to expedite the supply of a permanent progressive lens to the subject. Typically, manufacturing a progressive lens using a combination of base lens 22 and additional lens 24 of the type shown in FIG. 1 allows the temporary lens to be provided to the patient more quickly than if a single lens were to be shaped according to the subject's optical requirements. This is because the temporary progressive lens can typically be manufactured at a retail location using a relatively small stock of base lenses and additional lenses, whereas manufacturing a bespoke progressive lens using traditional manufacturing techniques is typically performed off-site at a laboratory.

For some applications, once the optical design of the subject's lens has been optimized using the techniques described herein, a non-temporary progressive lens that matches the optimized optical design is manufactured using traditional manufacturing techniques, in which a single lens is configured to provide all of the optical functionalities of the progressive lens. Alternatively, even a non-temporary lens that matches the optimized lens design is manufactured using a combination of a base lens and an additional lens of the type shown in FIG. 1.

It is well known that certain individuals do not adapt well to using progressive lenses, and prefer to use different corrective devices (e.g., glasses or contact lenses) for respective activities (such as reading, outdoors activities, working on a computer, etc.). For some applications, based upon the data that are received during the use of the temporary progressive lens by the subject, it is determined that the use of progressive lenses is not suitable for the subject.

For some applications, temporary lens 20 does not include coatings, such as an anti-scratch coating. Typically, this discourages the subject from using the temporary lens for longer than its intended temporary usage, since the lens will tend to become scratched within this period.

For some applications, the extent to which the subject's eyes need to be tested prior to providing temporary lens 20 is less than would typically be performed prior to ordering a non-temporary progressive lens for the subject. This is because, since lens 20 is only configured for temporary use and since the optical design for the permanent lens is optimized during the use of lens 20, even if lens 20 is not an exact match for the subject's optical requirements, this is typically acceptable.

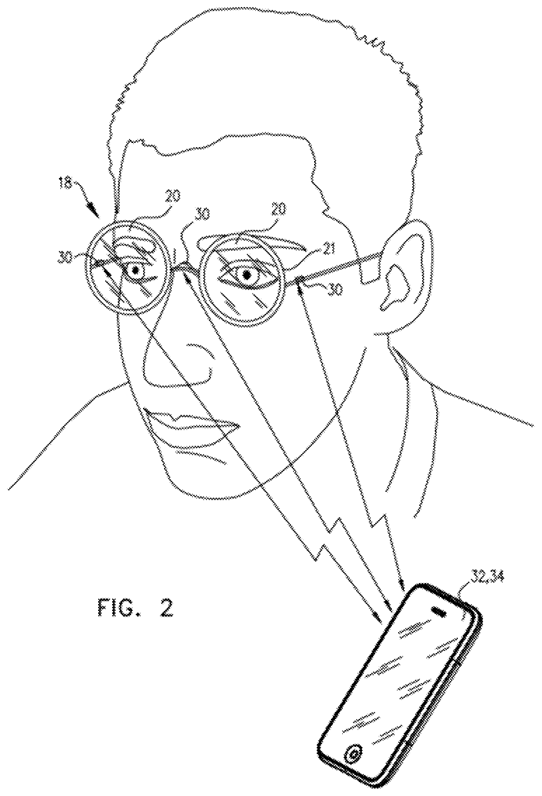

Reference is now made to FIG. 2, which is a schematic illustration of frame 21 of glasses 18, in accordance with some applications of the present disclosure. For some applications, one or more sensors 30 are coupled to frame 21. For example, the sensors may include one or more location and/or orientation sensors (e.g., accelerometers) and/or proximity sensors that are configured to provide sensor data that are indicative of when the glasses are removed from the subject's face, repositioned, or are placed upon the subject's face. Typically, the sensors are configured to communicate with a computer processor 32, which may, for example, be a computer processor of the subject's smartphone (or other electronic device) 34 that is running a program or an application that is configured to process the data received from the sensors. Alternatively or additionally, computer processor 32 may be integrated in frame 21, near the sensors 30, or elsewhere. The computer processor has wired and/or wireless interfaces to connect to other external computer processors and associated devices. For some applications, the data that are acquired by the sensors are stored and are then processed by a computer processor (e.g., a computer processor in the optician's office, or a remote, cloud-based computer processor) at a later stage. Removal of glasses or repositioning of the glasses on the wearer's nose are indicative of visual discomfort of the wearer. For some applications, in response to detecting that the subject's glasses have been removed or repositioned, the computer processor prompts the subject to provide a reason for the removal and/or repositioning of the glasses. For example, the computer processor may generate context-specific questions or provide the subject with choices regarding the reason for the removal. For some applications, such prompts are output on the subject's smartphone (or other electronic device).

For some applications, sensors 30 include a gyroscope (e.g., a solid-state gyroscope). Typically, the gyroscope provides data that are indicative of the subject's head position. For some applications, the sensors include one or more solid-state spirit levels that are configured to generate data that are indicative of the degree of the subject's head tilt (which, in turn, is indicative of the portion of the lens through which the subject is looking). For some applications, based upon these data, the computer processor derives how much time a subject spends utilizing near, intermediate and far-vision portions of the progressive lenses in his/her daily activities. For some applications, sensors 30 include a miniature camera that is configured to monitor the subject's pupils, and/or a miniature camera that is configured to monitor the subject's eyelids, such that the frequency and/or duration of the subject's blinks may be measured. Alternatively or additionally, the sensors include an ambient light sensor. For some applications, the sensors include a sensor (e.g., a range-finder) that is configured to measure the distance to viewed objects that correspond to the direction of the subject's gaze. For some applications, the sensors include a real-time clock, a motion-detection sensor, an accelerometer, a GPS locator, and/or a combination thereof, that are configured to provide data relating to the subject's movement, location, time-of-day, and speed of the subject (e.g., such as to determine whether the subject is driving, biking, running, walking, and/or stationary), while using the temporary progressive lens.

For some applications, data are provided that are indicative of a time of an activity, location of the subject, speed of travel of the subject, ambient light, traffic conditions, ambient weather conditions, physical activity of the subject, etc. Typically, based upon the additional data, the computer processor is able to determine general information regarding the subject's lifestyle (e.g., how much time do they spend reading, driving, watching television, outdoors, working in front of a computer screen, etc.) Further typically, based upon the additional data, the computer processor is able to automatically correlate the subject's ophthalmic needs, and/or level of ophthalmic comfort with respective activities. For example, the computer processor may determine that when the subject is working at a computer she/he often removes her/his glasses, or that when the subject is reading she/he often repositions her/his glasses, etc. Such data are typically acquired by the one or more sensors 30 that are coupled to frame 21, and/or by additional sensors that are in communication with the computer processor (e.g., sensors within the subject's smartphone, and/or other electronic device).

Typically, based upon the data that are acquired while the subject is using temporary progressive lens 20, parameters such as optimal corridor length and appropriate near-zone inset placement are optimized for the subject's permanent progressive lens. For some applications, based upon the data that are acquired while the subject is using temporary progressive lens 20, the overall size of the permanent progressive lens may be optimized, which will typically provide guidance to the subject regarding which frames are available for their use.

For some applications, based upon data acquired by sensors 30 (e.g., by an accelerometer, a gyroscope, and/or a camera), the computer processor determines where the subject lies along the spectrum of “eye movers” versus “head movers” with regards to their vision style. Based upon this, the computer processor typically optimizes the configuration of the non-temporary progressive lens. For example, in response to determining that subject is predominantly an “eye mover,” the computer processor may determine that the user will benefit from a lens design having relatively wide viewing zones, since the limited width of the viewing zones of many progressive lens designs may restrict lateral eye movement. Alternatively, in response to determining that subject is predominantly a “head mover,” the computer processor may determine that the user will benefit from a lens designs having a progression corridor that has a low magnitude of unwanted cylinder, yet is relatively narrow in viewing zones since this is not required by such subjects.

Referring again to FIG. 2, for some applications, frame 21 is a reusable frame that is used for more than one subject. Typically, different temporary progressive lenses are placed within the frame for respective subjects. For some applications, the temporary progressive lens 20 includes a base-and-additional-lens combination, as described hereinabove. For some such applications, the temporary progressive lens 20 for each of the subjects uses the same single-focus, far-vision corrective lens 22, but uses a different additional lens 24, in order to provide their specific optical requirements (e.g., distribution of unwanted cylinder and/or power addition for near-vision). Typically, each of the subjects uses frame 21 with their temporary lenses disposed therein for a temporary period (for example, for a period of between 2 hours and four weeks), before returning the frame to the optician.

For some applications, various parameters of frame 21 are indexed against a retailer's stock of available frames. Such parameters may include pantoscopic tilt, face-form wrap, and vertex distance. Typically, based upon data that are acquired using the techniques described hereinabove, the computer processor eliminates certain frame models which will not accommodate the subject's optical requirements, because of size or curvature constraints. Alternatively or additionally, based upon data that are acquired using the techniques described hereinabove, the computer processor suggests particular frame models which most readily accommodate the optimized optical design for the subject's lens.

It is noted that although some embodiments are described hereinabove as utilizing automatically-acquired data for optimizing the subject's progressive lens optical design, the scope of the present disclosure includes performing similar techniques but in which at least some data are provided to the computer processor by the subject. For example, as described hereinabove, the computer processor may prompt the subject to indicate a reason for the removal of their glasses. Alternatively or additionally, the subject themselves may provide an input to the computer processor indicating that they have removed their glasses and their reason(s) for doing so. Further alternatively or additionally, the subject may provide an input indicating an activity that they are currently engaged in, as well as an indication of a current level of ophthalmic discomfort.

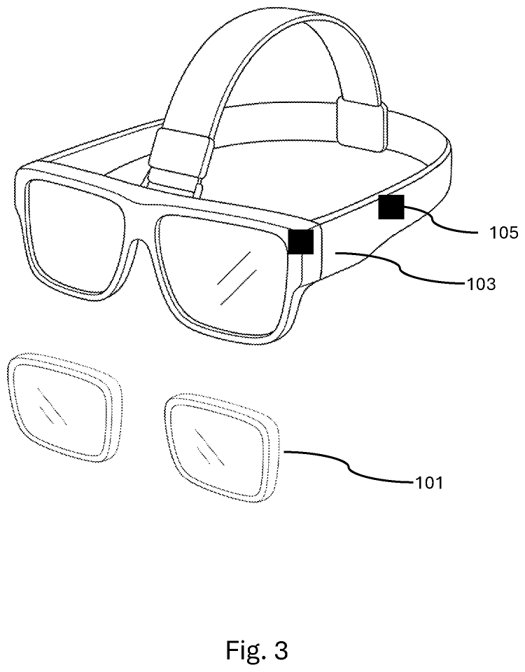

Reference is now made to FIG. 3, which is a schematic illustration of at least one temporary progressive lens 101 and an augmented-reality headset 103, in accordance with some applications of the present disclosure. For some applications, instead of the frame 21 of the glasses 18 of FIG. 2, the temporary progressive lens 101 and the augmented-reality headset 103 are used to determine an optimized optical design for a progressive lens. For some applications, the temporary progressive lens 101 is couplable and/or mountable to the augmented-reality headset 103. For some applications, the augmented-reality headset 103 includes slots and/or clips to receive the temporary progressive lens 101. For some applications, the temporary progressive lens 101 is coupled to an additional frame which is worn with the augmented-reality headset 103.

For some applications, in a similar manner to that explained above in relation to glasses 18, the temporary progressive lens 101 comprises a base lens and an additional lens, the base lens comprising a single-focus optically corrective lens, and the additional lens being configured to convert the base lens to a progressive lens. For some applications, the use of the base lens and the additional lens beneficially provide a practitioner with a large array of different individual progressive lenses to provide to the subject as the temporary progressive lens 101. For some applications, since various base lenses and various additional lenses can be combined in different ways, a large number of different individual prescriptions can easily and/or quickly be produced from a relatively small stock of lenses.

For some applications, using the augmented-reality headset 103 instead of frame 21 of FIG. 2 is beneficial because the augmented-reality headset 103 typically includes one or more sensors 105 for augmented-reality functionality. Therefore, for some applications, these existing sensors of the augmented-reality headset 103 are used to determine an optimized optical design for a progressive lens without the creation and/or manufacture of a bespoke frame and sensors.

For some applications, the augmented-reality headset 103 includes and/or is used with a computer processor 32. For example, the augmented-reality headset 103 includes an internal computer processor 32 and/or the augmented-reality headset 103 is in communication with an external computer processor 32 such as subject's smartphone (or other electronic device) 34.

For some applications, the computer processor 32 is configured to receive data that are indicative of suitability of the optical design for activities that are performed by the subject using the augmented-reality headset 103. For some applications, the data are generated during use of the temporary progressive lens 101 and the augmented-reality headset 103 by the subject. For some applications, the computer processor 32 is further configured to, based upon the received data, determine an optimized optical design for a progressive lens for use with the augmented-reality headset 103 for the subject. For some applications, the computer processor 32 is further configured to output the optimized optical design.

For some applications, the computer processor 32 is configured to receive the data by receiving data that are indicative of how use of the temporary progressive lens 101 correlates with performance of respective activities by the subject using the augmented-reality headset 103. For some applications, the computer processor 32 is configured to receive the data from the one or more sensors 105 of the augmented-reality headset 103.

For some applications, the one or more sensors 105 include sensors configured to acquire data that are indicative of when the glasses are removed from the subject's face, repositioned, and placed upon the subject's face. For some applications, the one or more sensors 105 configured to detect this include accelerometers, proximity sensors directed towards the subject's face, skin-contact detectors, pressure sensors and/or inertial measurement units.

For some applications, the one or more sensors 105 include sensors configured to acquire data that are indicative of a head position of the subject. For some applications, the one or more sensors 105 which are configured to detect this include inertial measurement units and/or solid-state tilt sensors.

For some applications, the one or more sensors 105 include cameras that are configured to monitor a pupil of an eye of the subject. For some applications, the one or more sensors 105 include cameras that are configured to monitor an eyelid of the subject. For some applications, the one or more sensors 105 include one or more light sensors that are configured to monitor a level of ambient light. For some applications, the one or more sensors 105 include sensors configured to measure a distance to viewed objects that correspond to a direction of a gaze of the subject. For some applications, the one or more sensors 105 include one or more solid-state spirit levels that are configured to generate data that are indicative of a degree of head tilt of the subject. In general, for some applications, the one or more sensors 105 include any of the sensors described hereinabove in relation to frame 21 and glasses 18.

For some applications, the one or more sensors 105 include cameras that are configured to record, detect and/or recognize external surroundings of the subject. For some applications, the one or more sensors 105 include outward-facing cameras for spatial mapping, scene understanding, and contextual cues about the wearer's current task and environment (e.g., desk work vs. walking).

For some applications, the data produced by any of and/or a combination of the aforementioned sensors 105 can be used to determine an optimized optical design for a progressive lens for use with the augmented-reality headset 103 for the subject, as explained in more detail hereinbelow.

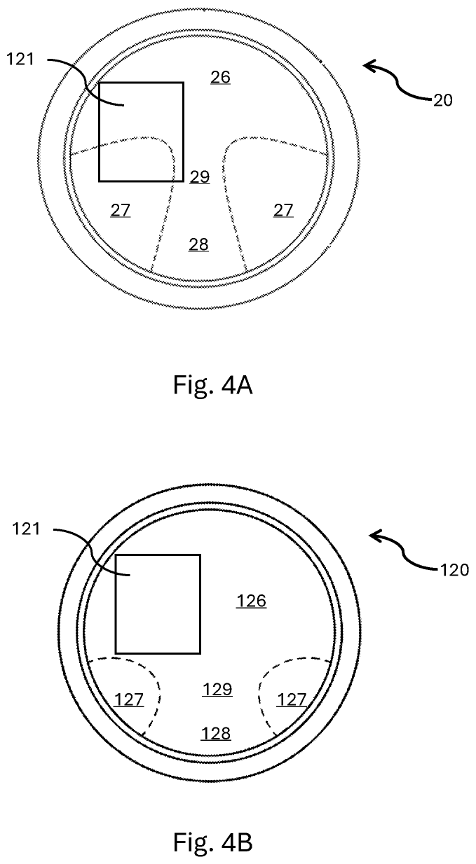

Reference is now made to FIGS. 4A and 4B, which are schematic illustrations of a progressive lens 20 not optimized for use with an augmented-reality headset (FIG. 4A) and an optimized progressive lens 120 optimized for use with an augmented-reality headset (FIG. 4B) respectively, in accordance with some applications of the present disclosure.

The progressive lens 20 of FIG. 4A is similar to the temporary progressive lens 20 shown in the enlarged portion of FIG. 1, and includes a far-vision corrective region 26, a near-vision corrective region 28, and a transition region 29. For some applications, the progressive lens 20 also includes peripheral distortion areas 27. For some applications, the peripheral distortion areas 27 are areas in which an image viewed therethrough is distorted. For some applications, the peripheral distortion areas 27 are artifacts of the way progressive lenses are designed.

FIG. 4A also shows a representative augmented-reality image 121 on a typical location of the progressive lens 20. As illustrated, for some applications, the representative augmented-reality image 121 overlaps with the peripheral distortion areas 27 and/or the transition region 29. For some applications, this leads to difficulty in viewing, blur and/or distortion of the representative augmented-reality image 121. Therefore, for some applications, a progressive lens can be optimized to avoid difficulty in viewing, blur and/or distortion of augmented-reality image data, such as the representative augmented-reality image 121, as explained in more detail in relation to FIG. 4B.

The optimized progressive lens 120 of FIG. 4B includes an optimized far-vision corrective region 126, an optimized near-vision corrective region 128, and an optimized transition region 129. For some applications, the optimized progressive lens 120 also includes optimized peripheral distortion areas 127. As illustrated, for some applications, the optimized progressive lens 120 has been modified relative to the progressive lens 20 of FIG. 4A by locating the optimized transition region 129 and the optimized peripheral distortion areas 127 lower down relative to the transition region 29 and peripheral distortion areas 27 respectively of the progressive lens 20 of FIG. 4A.

For some applications, as illustrated, this ensures that the representative augmented-reality image 121 does not overlap with the optimized peripheral distortion areas 127 and/or the optimized transition region 129. For some applications, this leads to ease in viewing, reduced blur and/or reduced distortion of the representative augmented-reality image 121. Therefore, for some applications, the optimized progressive lens 120 is optimized to avoid difficulty in viewing, blur and/or distortion of augmented-reality image data, such as the representative augmented-reality image 121. For some applications, the optimized progressive lens 120 ensures that augmented-reality image data do not overlap with the optimized peripheral distortion areas 127 but allows the augmented-reality image data to overlap with the optimized transition region 129 in a manner that allows for easy viewing.

For some applications, the optimized optical design for the progressive lens for use with the augmented-reality headset 103 is configured to ensure clarity in areas of the lens used for augmented-reality image data such as digital overlays. For some applications, this is accomplished by ensuring a prescription of the subject is adequately supported in the gaze direction and distance where augmented-reality notifications are presented. For example, for some applications, augmented-reality image data such as digital overlays often appear in certain regions of the subject's field of view and at a fixed focal distance (typically around 2 m). For some applications, the optimized optical design is designed such that the lens region corresponding to the location of typical augmented-reality image data is optimized for optical clarity in this location. For example, if augmented-reality image data such as notifications or text tend to hover in the upper-right field of the lens at around 2 m distance, for some applications, the optimized optical design for the progressive lens ensures the wearer's prescription is adequately supported in that gaze direction and distance, which may fall in the optimized transition region 129 of the lens. For some applications, to accomplish this, the transition region 129 of the lens is shifted and/or widened and/or a sweet spot of the lens (an area of the lens with the clearest, most stable vision and/or minimal distortion) is created aligned with this location. For some applications, this results in digital content being sharply in focus for the user, enhancing usability of the augmented-reality headset.

For some applications, the optimized optical design is generally configured to ensure clarity in areas of the lens used for digital overlays by shifting or widening an intermediate corridor and/or creating a sweet spot of the progressive lens aligned with a projection angle of the augmented-reality headset.

For some applications, the optimized optical design for the progressive lens for use with the augmented-reality headset 103 is configured to mitigate augmented-reality-induced visual strain. Typically, use of augmented-reality can cause augmented-reality-induced visual strain due to a mismatch between where the eyes converge and where they focus, leading to eye strain. For some applications, augmented-reality-induced visual strain is mitigated by providing a clear optical zone in the gaze direction and distance where augmented-reality data are typically presented to reduce the effort required by the eye of the subject to view the augmented-reality data. For some applications, the augmented-reality data includes graphics, menus, and/or holograms. For some applications, augmented-reality-induced visual strain is mitigated by distributing add power across the lens for more comfortable viewing of augmented-reality content, and/or for reducing effort for the subject when switching between real-world and augmented-reality objects.

For some applications, the optimized optical design for the progressive lens for use with the augmented-reality headset 103 is configured to minimize distortion in augmented-reality interaction areas. As explained above, for some applications, progressive lenses inherently have peripheral distortion areas 27 such as peripheral aberrations and/or “swim” distortion in areas away from the optical center. When using the augmented-reality headset 103, important interactive elements (such as menus, holograms, and/or hand-tracking cues) often appear in the periphery of the view, in areas which are typically within peripheral distortion areas 27. Therefore, for some applications, the optimized peripheral distortion areas 127 are designed such that they do not overlap with areas of the periphery of the view in which interactive elements are displayed. For some applications, the optimized optical design is configured to minimize distortion in augmented-reality interaction areas by reducing astigmatism and distortion in regions where augmented-reality graphics, menus, and/or holograms often appear.

As explained above, the computer processor 32 is further configured to, based upon the received data, determine the optimized optical design for the progressive lens for use with the augmented-reality headset 103 for the subject, which is now described in more detail.

For some applications, during use of the augmented-reality headset 103 and temporary progressive lens 101, the computer processor 32 obtains usage data, for example by logging gaze vectors and head pose together with augmented-reality rendering and/or interaction metadata (for example, which user interface elements are displayed, their positions and/or angular positions, their virtual depths, and/or interaction events such as selection and dwell).

For some applications, a calibration step estimates the relationship between the eyes of the subject, a coordinate frame of the augmented-reality headset 103, and an ophthalmic lens plane (including lens tilt and wrap). Using this, for some applications, the computer processor 32 maps viewing rays from the augmented-reality headset 103 to corresponding regions on the lens. For some applications, this provides data regarding how the augmented-reality data are typically viewed by the subject, which can inform on the optimized lens design.

For some applications, using the usage data, the computer processor 32 identifies which gaze directions and/or vectors the user frequently engages with augmented-reality content. For some applications, virtual-content gaze distribution is obtained using augmented-reality headset 103 rendering metadata (for example, virtual object pose, angular location in the display, and virtual depth or virtual image distance) together with gaze vectors to estimate a distribution of where augmented-reality viewing rays intersect an ophthalmic lens plane. For some applications, the computer processor 32 thereby determines the optimized optical design for the progressive lens by prioritizing reducing astigmatism and distortion in zones corresponding to the aforementioned gaze directions. For some applications, the computer processor 32 thereby determines the optimized optical design for the progressive lens for use with augmented-reality headset 103 by minimizing disruptive effects in high-use augmented-reality interaction areas. For some applications, this is accomplished by shaping the various areas of the optimized progressive lens 120, such as the optimized transition region 129 so that the regions most used for augmented-reality interaction are prioritized for clarity and reduced aberration.

For some applications, when the subject removes or repositions the augmented-reality headset 103, the computer processor 32 detects the event (for example, via accelerometer and/or proximity signals) and/or prompts the subject to select one or more reasons for their action. For some applications, the reasons supplied by the subject and time windows of the actions are linked to the immediately preceding augmented-reality and/or real-world viewing conditions. For some applications, this can provide comfort and performance feedback tied to the present use of the augmented-reality headset 103. For some applications, this provides data on which augmented-reality and real-world viewing conditions cause the subject eye discomfort due to the temporary progressive lens 101 design, and therefore how to modify the progressive lens to obtain the optimized optical design.

For some applications, in general, the computer processor 32 uses an optimization routine to adjust progressive lens parameters (e.g., transition region and/or corridor placement and/or trajectory, intermediate zone centroid/width, and selected aberration distribution) to maximize a weighted objective function optionally driven by (i) the mapped augmented-reality viewing distribution and (ii) the removal/reposition reasons.

As described hereinabove, for some applications, the computer processor 32 is further configured to output the optimized optical design. For some applications, an optimized progressive lens is then manufactured according to the optimized optical design. Therefore, an optimized optical design and/or optimized progressive lens which is specifically designed for use with the augmented-reality headset 103, based on the subject's individual augmented-reality viewing habits, can be obtained for the subject.

Applications of the disclosure described herein can take the form of a computer program product accessible from a computer-usable or computer-readable medium (e.g., a non-transitory computer-readable medium) providing program code for use by or in connection with a computer or any instruction execution system, such as computer processor 32. For the purposes of this description, a computer-usable or computer readable medium can be any apparatus that can comprise, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Typically, the computer-usable or computer readable medium is a non-transitory computer-usable or computer readable medium.

Examples of a computer-readable medium include a semiconductor or solid state memory, magnetic tape, a removable computer diskette, a random-access memory (RAM), a read-only memory (ROM), a rigid magnetic disk, an optical disk, and a magnetic storage device. Examples of optical disks include compact disk-read only memory (CD-ROM), compact disk-read/write (CD-R/W) and DVD.

A data processing system suitable for storing and/or executing program code will include at least one processor (e.g., computer processor 32) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. The system can read the inventive instructions on the program storage devices and follow these instructions to execute the methodology of the embodiments of the disclosure.

Network adapters may be coupled to the processor to enable the processor to become coupled to other processors or remote printers or storage devices through intervening private or public networks. Modems, cable modem and Ethernet cards are just a few of the currently available types of network adapters.

Computer program code for carrying out operations of the present disclosure may be written in any combination of one or more programming languages, including an object-oriented programming language such as Java, Smalltalk, C++ or the like and conventional procedural programming languages, such as the C programming language or similar programming languages.

It will be understood that algorithms described herein, can be implemented by computer program instructions. These computer program instructions may be provided to a processor of a general-purpose computer, special purpose computer, or other programmable data processing apparatus to produce a machine, such that the instructions, which execute via the processor of the computer (e.g., computer processor 32) or other programmable data processing apparatus, create means for implementing the functions/acts specified in the algorithms described in the present application. These computer program instructions may also be stored in a computer-readable medium (e.g., a non-transitory computer-readable medium) that can direct a computer or other programmable data processing apparatus to function in a particular manner, such that the instructions stored in the computer-readable medium produce an article of manufacture including instruction means which implement the function/act specified in the algorithms. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the algorithms described in the present application.

Computer processor 32 is typically a hardware device programmed with computer program instructions to produce a special purpose computer. For example, when programmed to perform the algorithms described herein, computer processor 32 typically acts as a special purpose ophthalmic-analysis computer processor. Typically, the operations described herein that are performed by computer processor 32 transform the physical state of a memory, which is a real physical article, to have a different magnetic polarity, electrical charge, or the like depending on the technology of the memory that is used.

It will be appreciated by persons skilled in the art that the present disclosure is not limited to what has been particularly shown and described hereinabove. Rather, the scope of the present disclosure includes both combinations and subcombinations of the various features described hereinabove, as well as variations and modifications thereof that are not in the prior art, which would occur to persons skilled in the art upon reading the foregoing description.

1. An apparatus for use with a temporary progressive lens configured for temporary use by a subject, based upon an initial progressive-lens optical design, with a frame in which the temporary progressive lens is configured to be placed, the frame being configured to be worn by the subject and comprising one or more sensors configured to acquire data that are indicative of use of the temporary progressive lens by the subject, while the subject performs activities, the apparatus comprising at least one computer processor configured to:
receive the data from the sensors;
based upon the received data, detect when the frame is removed from and/or repositioned on the subject's face;
in response to detecting instances of the frame having been removed from and/or repositioned on the subject's face, receiving an input from the subject indicating their reasons for the frame having been removed from and/or repositioned on the subject's face;
based upon the received data and the reasons provided by the subject for the frame having been removed from and/or repositioned on the subject's face, determine an optimized optical design for a progressive lens for the subject; and
output the optimized optical design.

2. The apparatus according to claim 1, wherein the computer processor is configured to receive the data by receiving data that are indicative of how much time the subject spends performing respective activities.

3. The apparatus according to claim 1, wherein the computer processor is configured to receive the data by receiving data that are indicative of how use of the temporary progressive lens correlates with performance of respective activities by the subject.

4. The apparatus according to claim 1, wherein the one or more sensors are disposed on a frame of glasses that is configured to hold the temporary progressive lens.

5. The apparatus according to claim 4, wherein the one or more sensors are configured to acquire data that are indicative of a head position of the subject.

6. The apparatus according to claim 4, wherein the one or more sensors comprise one or more cameras that are configured to monitor a pupil of an eye of the subject.

7. The apparatus according to claim 4, wherein the one or more sensors comprise one or more cameras that are configured to monitor an eyelid of the subject.

8. The apparatus according to claim 4, wherein the one or more sensors comprise one or more light sensors that are configured to monitor a level of ambient light.

9. The apparatus according to claim 4, wherein the one or more sensors comprise one or more sensors that are configured to measure a distance to viewed objects that correspond to a direction of a gaze of the subject.

10. The apparatus according to claim 4, wherein the one or more sensors comprise one or more solid-state spirit levels that are configured to generate data that are indicative of a degree of head tilt of the subject.

11. A method for use with a temporary progressive lens that is configured for a subject's temporary use, based upon an initial progressive-lens optical design, wherein the temporary progressive lens is placed inside a frame that is configured to be worn by the subject, the method comprising, by means of at least one computer processor:
receiving data from one or more sensors that are associated with the frame and that are configured to detect when the frame is removed from and/or repositioned on the subject's face, while the subject performs activities;
in response to detecting instances of the frame having been removed from and/or repositioned on the subject's face, receiving an input from the subject indicating their reasons for the frame having been removed from and/or repositioned on the subject's face;
based upon the received data and the reasons provided by the subject for the frame having been removed from and/or repositioned on the subject's face, determining an optimized optical design for the progressive lens; and
outputting the optimized optical design.

12-25. (canceled)

26. An apparatus for use with a temporary progressive lens configured for temporary use by a subject, based upon an initial progressive-lens optical design, and an augmented-reality headset, the apparatus comprising at least one computer processor configured to:
receive data from the augmented-reality headset that are indicative of suitability of the optical design for activities that are performed by the subject using the augmented-reality headset, the data being generated during use of the temporary progressive lens and the augmented-reality headset by the subject;
based upon the received data, determine an optimized optical design for a progressive lens for use with the augmented-reality headset for the subject; and
output the optimized optical design.

27. The apparatus according to claim 26, wherein the augmented-reality headset comprises one or more sensors and the at least one computer processor is configured to receive the data that are indicative of suitability of the optical design for activities that are performed by the subject using the augmented-reality headset from the one or more sensors.

28. The apparatus according to claim 27, wherein the one or more sensors comprise sensors selected from the group consisting of:
sensors configured to acquire data that are indicative of when the augmented-reality headset is removed from the subject's face, repositioned, and placed upon the subject's face;
sensors configured to acquire data that are indicative of a head position of the subject;
cameras that are configured to monitor a pupil of an eye of the subject;
cameras that are configured to monitor an eyelid of the subject;
one or more light sensors that are configured to monitor a level of ambient light;
sensors configured to measure a distance to viewed objects that correspond to a direction of a gaze of the subject;
one or more solid-state spirit levels that are configured to generate data that are indicative of a degree of head tilt of the subject; and
cameras that are configured to detect external surroundings of the subject.

29. The apparatus according to claim 26, wherein:
the temporary progressive lens comprises a base lens and an additional lens, the base lens comprising a single-focus optically corrective lens, and the additional lens being configured to convert the base lens to a progressive lens; and
the at least one computer processor is configured to receive the data that are indicative of suitability of the optical design for activities that are performed by the subject using the augmented-reality headset, the data being generated during use of the temporary progressive lens comprising the base lens and the additional lens.

30. The apparatus according to 26, wherein the computer processor is configured to receive the data by receiving data that are indicative of how use of the temporary progressive lens correlates with performance of respective activities by the subject using the augmented-reality headset.

31. The apparatus according to 26, wherein the at least one computer processor is configured to determine the optimized optical design based on data indicative of areas of the lens used for digital overlays to ensure clarity in the areas of the lens.

32. The apparatus according to claim 31, wherein the at least one computer processor is configured to determine the optimized optical design by determining a gaze direction and distance at which augmented-reality notifications are presented and ensuring that a prescription of the subject is adequately supported at the determined gaze direction and distance.

33. The apparatus according to claim 31, wherein the at least one computer processor is configured to determine the optimized optical design by shifting or widening an intermediate corridor of the progressive lens aligned with a projection angle of the augmented-reality headset.

34. The apparatus according to 26, wherein the at least one computer processor is configured to determine the optimized optical design based on a gaze direction and distance at which augmented-reality data are presented, so as to mitigate augmented-reality-induced visual strain.

35. The apparatus according to claim 34, wherein the at least one computer processor is configured to determine the optimized optical design by providing a clear optical zone in the gaze direction and distance where augmented-reality data are presented to reduce the effort required by an eye of the subject.

36. The apparatus according to claim 34, wherein the at least one computer processor is configured to determine the optimized optical design by distributing add power across the lens for more comfortable viewing of augmented-reality content.

37. The apparatus according to 26, wherein the at least one computer processor is configured to determine the optimized optical design based on augmented-reality data indicative of regions where augmented-reality data often appear, so as to minimize distortion in augmented-reality interaction areas.

38. The apparatus according to claim 37, wherein the at least one computer processor is configured to determine the optimized optical design by reducing astigmatism and distortion in regions where augmented-reality data often appear.

39-40. (canceled)
